(19) United States
(12) Patent Application Publication
(10) Pub. No.: US 2022/0218000 A1
(43) Pub. Date: Jul. 14, 2022

(54) ADDITIVE FOR INCREASING THE REPRODUCTIVE FUNCTIONS AND FERTILITY OF INSECTS

(71) Applicant: Entomo Ventures Pte. Ltd., Singapore (SG)

(72) Inventors: Dmitry Mikhaylovich MIKHAYLOV, Moscow (RU); Aleksei Valentinovich KRAMARENKO, Cheboksary (RU); Ilman SHAZHAEV, Dubai (AE)

(21) Appl. No.: 17/145,018

(22) Filed: Jan. 8, 2021

(51) Int. Cl. A23K 20/174; A23K 20/142; A23K 20/163; A23K 20/105; A23K 50/90

(52) U.S. Cl. CPC A23K 20/174; A23K 20/142; A23K 50/90; A23K 20/105; A23K 20/163

(57) ABSTRACT

The present technology generally relates to compounds for stimulating the reproductive and fertile functions of insects of the order of Orthoptera. In particular, the present technology relates to amino acid compositions and their derivatives in the nutrition of insects.

### FIELD OF TECHNOLOGY

The present technology generally relates to compounds for stimulating the reproductive and fertile functions of insects of the order of Orthoptera. In particular, the present technology relates to amino acid compositions and their derivatives in the nutrition of insects.

### BACKGROUND

Orthoptera insects cultivated in agriculture are complex organisms that feed on organic residues. It is desirable to get the highest reproduction and fertility from insects. Compositions can be used to increase the reproduction and fertility of insects. However, conventional compositions may comprise unbalanced proportions of substances, resulting in limited utility and effectiveness.

It would thus be desirable to provide a composition and a method for increasing the reproduction and fertility of insects.

### BRIEF DESCRIPTION

In one embodiment, the present technology provides for an improved composition for feeding to insects to stimulate their reproductive and fertile functions. In some implementations, the composition is used as an additive to the insects main feed. In some implementations, the insects are of the order of Orthoptera, as well varieties thereof. As used herein, the terms “composition” and “additive may be used interchangeably.

In some embodiments, the composition of the present technology can increase the rate of reproduction of insects, and in particular, and increase in fertility. In one or more embodiments, the composition of the present technology provides insects with resistance to stress factors caused by a lack of nutrition elements, including immunomodulatory effects. Non-exhaustive examples of stress factors include cold, heat, chemical poisoning, and fungal diseases.

In some embodiments, the composition of the present technology includes: water-soluble compounds such as an amino acid or combinations of amino acids; vitamins B; glucose; and at least one carboxylic acid (such as citric acid; malic acid; succinic acid); and a solvent compound which are calculated by volume of the total composition.

In some embodiments, the composition of the present technology can stimulate reproduction and fertility with resistance to stress factors with efficiency and speed due to the good digestibility and high rate of absorption of the composition by insects. Good permeability and high absorption rate can be the result of the ultra-small size of the active substances in the composition.

In some implementations, the composition increases insect life expectancy, reduces unstable reproduction, and improves egg fertilization. The composition of the present technology provides a supplement to the insect's normal diet with additional foods that contains items to achieve intensive reproduction and fertility of the insect.

In some embodiments, the composition of the present technology can be dissolved, and the dissolved composition can be included in the drinking solution and can also act as a growth stimulant on the entire insect body, activating its metabolism. The composition can be used at least with any kind of food by mixing it. The composition allows to increase the reproductive function of insects, increase the number of eggs laid, their fertility and healthy offspring, increase the life span, resistance of insects to stress factors such as cold, heat, chemical poisoning, fungal diseases (including, but not limited to: microsporidia, Nosema (microsporidian), Penicillium, Aspergillus).

### DETAILED DESCRIPTION

This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which variations and additions do not depart from the present technology. Hence, the following description is intended to illustrate some particular embodiments of the technology, and not to exhaustively specify all permutations, combinations and variations thereof.

As used herein, the singular form “a,” “an” and “the” include plural referents unless the context clearly dictates otherwise. The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

In some embodiments, the present technology provides a composition that stimulates the insect's reproduction and fertility and provides stress resistance of the insect during its lifetime.

In some embodiments, the present technology provides for a composition for stimulating reproductive growth of an insect, increasing fertility of an insect, and for resistance to insect stressors. The composition comprises: at least one amino acid, such as isoleucine, vitamin B; glucose and at least one carboxylic acid, the rest is a water-soluble protein as a carrier. In some instances, vitamin B₆ is present in an amount ranging from 0.009% to about 1.5% by volume of the total composition.

In some embodiments, the present technology provides for a composition for stimulating reproductive growth of an insect, increasing fertility of an insect, and for resistance to insect stressors.

In some embodiments, the composition comprises: at least one amino acid, such as isoleucine, vitamin B; glucose and at least one carboxylic acid, the rest is a water-soluble protein as a carrier. In some instances, vitamin B₆ is present in an amount ranging from 0.009% to about 1.5% by volume of the total composition.

In some embodiments, the composition can be either in dry form, such as powdered, or in liquid form, such as an emulsion or suspension, or similar.

In some embodiments, the composition can be mixed with water at a temperature of approximately 18° C. to about 25° C. with the formation of a ready-made drinking solution in a drinking bowl for insects.

In some embodiments, the composition can be diluted with water in the proportion of approximately 1 part of the composition to 1000 parts of water.

In some embodiments, the composition can be mixed with any non-liquid feed to form a ready-made solution in an insect feeder.

In some embodiments, the composition can be mixed with feed in the proportion of approximately 1 part of the composition to approximately 1000 parts of the feed.

An existing problem in traditional insect cultivation is feed containing low levels of digestible proteins, as well as a lack of amino acids, which changes the behavior and health of insects. For example, the presence of soy products containing trypsin-serine protease inhibitors and Bowman-Birk inhibitor (BBI) proteases as the main source of protein, which prevent the cleavage of the peptide bond between amino acids in proteins. As a result, there are problems with the digestion of food in insects, and low protein levels significantly reduce the level of reproduction and fertility, leading to premature death of the insect.

To solve this problem, the composition of the present technology includes amino acids that are directly involved in protein synthesis, as well as the rate of hydrolysis in the intestines of insects.

The presence in the diet of all the necessary elements for proper growth and reproduction is as important as the lack of nutrients in the feed, affects the life expectancy, the number postpone eggs, number of fertilized eggs, number of emerged insect eggs. The composition described herein can be used to ensure maximum reproduction and fertility of the insect.

In the diet of many insects, glucose is the main source of energy for ensuring metabolic processes. Glucose is a substrate of glycolysis, during which it can be oxidized either to pyruvate in aerobic conditions, or to lactate in the case of anaerobic conditions. Pyruvate, thus obtained in glycolysis, is further decarboxylated, turning into acetyl-COA (acetylcoenzyme A). Also, during the oxidative decarboxylation of pyruvate, the coenzyme NAD⁺ is reduced. Acetyl-COA is further used in the Krebs cycle, and the reduced coenzyme is used in the respiratory chain. As described above, glucose can be included in the composition in an amount of about 2.0% to about 20% by volume of the total composition.

The role of vitamin B in the nutrition of insects is to regulate the redox reactions of the formation of enzymes, as well as the exchange of lipids and carbohydrates in living cells. All vitamins B are co-enzymes that improve tissue adaptation and growth and are also used to stimulate biochemical reactions in the cell.

In some embodiments, the presence of pyridoxine in the composition has a stimulating effect on the development of insects, since it is a participant in macronutrient metabolism, neurotransmitter synthesis, histamine, gluconeogenesis, and gene expression. As described above, the composition may include vitamin B₆ (or as pyridoxine C₈H₁₁NO₃) in an amount of approximately 0.009% to approximately 1.5% by volume of the total composition.

Citric acid along with malic and succinic acids, is a key link in the tricarboxylic acid cycle. The tricarboxylic acid cycle is: responsible for the respiration stage of all cells using oxygen; the center of intersection of many metabolic pathways in the body; and is used in the intermediate stage between glycolysis and the electron transport chain. In addition to a significant energy role, the cycle is also assigned a significant plastic function, that is, it is an important source of precursor molecules, which form such important compounds for cell life, as amino acids, carbohydrates, fatty acids, etc.

In some embodiments, the composition comprises 2-Hydroxypropane-1,2,3-tricarboxylic acid C₆H₈O₇, in an amount of approximately 0.1% to approximately 2.5% of the total composition.

In some embodiments, carboxylic acid may include hydroxybutanedioic acid C₄H₆O₅ in an amount of approximately 0.5% to approximately 10.5% of the total composition.

In some embodiments, the composition comprises ethane-1,2-dicarboxylic acid C₄H₆O₄ in amounts from about 0.5% to about 10.0% of the total composition.

Amino acids are the main ingredients in the protein synthesis process Amino acids can directly or indirectly affect the physiological activity of the plant. Amino acids can be delivered to insects through food, water or other drinking solution. This can help in better absorption of nutrients Amino acid supplementation can provide ready-made building blocks for protein synthesis Amino acids can be included in the composition due to their participation in various metabolic processes in order Opthoptera insects. In some embodiments, the amino acids in the composition may belong to at least one of the D-isomers, L-isomers, and DL-isomers.

In some embodiments, the composition comprises 2-aminobutanedioic acid C₄H₇NO₄, in a total amount of approximately 0.5% to approximately 10.0% by volume of the total composition.

In some embodiments, the composition comprises 2-amino-4-methylpentanoic acid C₆H₁₃NO2 and 2-Amino-3-methylbutanoic acid C₅H₁₁NO₂, in a total amount of approximately 5% to approximately 25% by volume of the total composition. The ratio of acids 2-amino-4-methylpentanoic acid C₆H₁₃NO₂ to 2-Amino-3-methylbutanoic acid C₅H₁₁NO₂, can be four parts 2-amino-4-methylpentanoic acid C₆H₁₃NO₂ to three parts 2-Amino-3-methylbutanoic acid C₅H₁₁NO₂.

In some embodiments, the composition comprises (2S,3S)-2-amino-3-methylpentanoic acid C₆H₁₃NO₂ in a total amount of approximately 0.1% to approximately 8.0% of the total volume of the composition.

In some embodiments, the composition comprises (2S)-pyrrolidine-2-carboxylic acid C₅H₉NO₂ in a total amount of approximately 0.1% to approximately 2.0% of the total volume of the composition.

In some embodiments, the carboxylic acid in the composition may be the amino acid 2-amino-4-(methylthio) butanoic acid C₅H₁₁NO₂S in a total amount of approximately 0.1% to approximately 3.5% of the total volume of the composition.

In some embodiments, the composition comprises citrulline C₆H₁₃N₃O₃ in a total amount of approximately 0.5% to approximately 10.5% of the total composition.

In some embodiments, the composition comprises an α-amino acid such as 2-amino-5-guanidinpentanoic acid C₆H₁₄N₄O₂ in a total amount of approximately 0.5% to approximately 5.0% of the total composition.

In some embodiments, the composition comprises an α-amino acid such as (2S)-2-aminopropanoic acid C₃H₇NO₂ in a total amount of approximately 0.5% to approximately 15.0% of the total composition.

In some embodiments, the composition comprises (2S)-2,5-diamino-5-oxopentanoic acid C₅H₁₀N₂O₃ in a total amount of approximately 2.5% to approximately 25.0% of the total composition.

The present technology has been described in terms of several embodiments for illustrative purposes only. Specialists in this field of technology will learn from this description that the invention is not limited to the described implementation options but can be implemented with modifications and changes limited only by the spirit and scope of the attached claim.

1. A water-soluble composition for stimulating growth of reproduction of an insect, increasing fertility of an insect, and for improving resistance of an insect to insect stress factors, the composition comprising:
at least one amino acid;
vitamin B₆ in an amount ranging from between about 0.009% and about 1.5% of total volume of the composition;
glucose in an amount ranging from about 2.0% to about 20% of total volume of the composition; and
at least one carboxylic acid.

2. The composition of claim 1, wherein the at least one amino acid is isoleucine.

3. The composition according to claim 1, wherein the at least one carboxylic acid is 2-Hydroxypropane-1,2,3-tricarboxylic acid and is present in the composition in an amount ranging between about 0.1% and about 2.5% of the total volume of the composition.

4. The composition according to claim 1, wherein the at least one carboxylic acid is hydroxybutanedioic acid and is present in the composition in an amount ranging between about 0.5% and about 10.5% of the total volume of the composition.

5. The composition according to claim 1, wherein the at least one carboxylic acid is ethane-1,2-dicarboxylic acid and is present in the composition in an amount ranging from about 0.5% and about 10.0% of the total volume of the composition.

6. The composition according to claim 1, wherein the at least one amino acid is 2-aminobutanedioic acid and is present in the composition in an amount ranging from between about 0.5% and about 10.0% of the total volume of the composition.

7. The composition according to claim 1, wherein the at least one amino acid is 2-amino-4-methylpentanoic acid and 2-Amino-3-methylbutanoic acid present in the composition in an amount ranging from between about 5.0% and about 25.0% of the total volume of the composition.

8. The composition of claim 7, wherein 2-amino-4-methylpentanoic acid to 2-Amino-3-methylbutanoic acid ratio is four parts 2-amino-4-methylpentanoic acid to three parts 2-Amino-3-methylbutanoic acid.

9. The composition according to claim 1, wherein the at least one amino acid is (2S,3S)-2-amino-3-methylpentanoic acid and is present in the composition in an amount ranging from between about 0.1% and about 6.0% of the total volume of the composition.

10. The composition according to claim 1, wherein the at least one amino acid is acid (2S)-pyrrolidine-2-carboxylic acid and is present in the composition in an amount ranging from between about 0.1% and about 2.0% of the total volume of the composition.

11. The composition according to claim 1, wherein the at least one amino acid is 2-amino-4-(methylthio) butanoic acid and is present in the composition in an amount ranging from about 0.1% and about 3.5% of the total volume of the composition.

12. The composition according to claim 1, wherein the at least one amino acid is citrulline and is present in the composition in an amount ranging from about 0.5% and about 10.5% of the total volume of the composition.

13. The composition according to claim 1, wherein the at least one amino acid is 2-amino-5-guanidinpentanoic acid and is present in the composition in an amount ranging from about 0.5% and about 5.0% of the total volume of the composition.

14. The composition according to claim 1, wherein the least one amino acid is (2S)-2-aminopropanoic acid and is present in the composition in an amount ranging from about 0.5% and about 15.0% of the total volume of the composition.

15. The composition according to claim 1, wherein the at least one amino acid is (2S)-2,5-diamino-5-oxopentanoic acid and is present in the composition in an amount ranging from about 2.5% and about 25.0% of the total volume of the composition.

16. The composition according to claim 1, wherein the composition is in a dry form.

17. The composition of claim 16, wherein the composition is a powder.

18. The composition of claim 1, wherein the composition is a liquid.

19. The composition of claim 18, wherein the composition is an emulsion or a suspension.

20. A food product for insect, the food product comprising the composition of claim 1.
